(19) United States
(12) Patent Application Publication
(10) Pub. No.: US 2015/0310026 A1
(43) Pub. Date: Oct. 29, 2015

(54) ACCESSING LOGICAL STORAGE IN A STORAGE CLUSTER

(71) Applicant: International Business Machines Corporation, Armonk, NY (US)

(72) Inventors: Lei Chen, Shanghai (CN); Min Fang, Shanghai (CN); Xiao Yan Li, Shanghai (CN)

(21) Appl. No.: 14/644,420

(22) Filed: Mar. 11, 2015

(30) Foreign Application Priority Data
Apr. 29, 2014 (CN) 201410178088.6

(51) Int. Cl. G06F 17/30; H04L 29/08

(52) U.S. Cl. CPC G06F 17/3087; G06F 17/30371; G06F 17/30575; H04L 67/1097

(57) ABSTRACT

Embodiments of the present disclosure include a method and apparatus for accessing a logical storage in a storage cluster, the storage cluster comprising a plurality of sites at different locations, each site among the plurality of sites comprising a copy corresponding to the logical storage. The method may include, in response to receiving an access request from a client, obtaining a location of the client, selecting one site from the plurality of sites at least based on distances from the location of the client to locations of the plurality of sites, and accessing the logical storage by accessing a copy at the selected site. There may be provided an apparatus for accessing a logical storage in a storage cluster. A storage controller at a site that is nearer to the client physically or logically may respond to the access request from the client.

### BACKGROUND

Various embodiments of the present disclosure relate to storage management, and more specifically, to a method and apparatus for accessing a logical storage in a storage cluster.

With the development of data storage technology, a variety of data storage devices can provide users with increasing data storage capacity, and the data access speed has also been increased. In addition, the development of network technology opens up a new direction for data storage; data storage devices are no longer limited to be deployed on access devices locally but may be located at any network-accessible physical location.

Solutions have been proposed involving a storage cluster that can provide users requiring large amounts of data with a data storage function. In this solution, a storage cluster may include a plurality of storage servers distributed across a plurality of physical locations. A user of the storage cluster does not have to care about a physical location of a storage server being accessed, but can execute data read/write operations simply by accessing logical storage identifier which the storage cluster shows to the users.

To enhance the reliability of data, the storage cluster may deploy storage servers across a plurality of physical locations and provide more copies of the same data in a plurality of storage servers, so that when one or more storage servers in the storage cluster have failures, users may be served by other storage servers. For example, a provider of storage service may deploy storage servers across a plurality of cities like Beijing and Shanghai; when the user performs read/write operations to a logical storage via a client, the user does not need to know a topological structure inside the storage cluster.

The logical storage may be presented to the client as a logical unit number (LUN) and specifically, in a logical drive form (suppose there exist in the user's client device physical storage “C: Drive” and “D: Drive”, then the logical drive may be presented as an “F: Drive” form separately). At this point, by clicking on the “F: Drive,” the user can use storage service provided by the storage cluster. Generally speaking, a preferred node (i.e., a storage controller in the storage cluster) is specified for the logical storage, the preferred node being used for controlling communication between a physical storage to which the client device and the logical storage are allowed to be mapped.

A problem may arise from using the distributed storage cluster. For example, a user in Beijing wants to access a specific virtual storage (e.g., “F: Drive”), and a preferred node of the virtual storage is a storage controller in Shanghai, so data needs to be transmitted via a network between Beijing and Shanghai. Because Beijing and Shanghai are physically distant from each other and/or network communication bandwidths therebetween are rather unsatisfactory, problems may arise that the storage cluster's response time to data accesses by users gets longer and the data access efficiency is decreased. Therefore, increasing the data access efficiency in the storage cluster becomes a research focus.

### SUMMARY

It may be desirable to develop a storage solution capable of reducing the response time of a storage cluster and increasing its data access efficiency. In addition, it may also be desirable that the solution only relates to modifications inside the storage cluster that are invisible to a client, so that the client can perform efficient data access operations without a need to know operational details inside the storage cluster.

According to aspects of the present disclosure, there is provided a method for accessing a logical storage in a storage cluster, the storage cluster comprising a plurality of sites at different geographical locations, each site among the plurality of sites comprising a copy of data corresponding to the logical storage, the method comprising: in response to receiving an access request from a client, obtaining a location of the client; selecting one site from the plurality of sites at least based on distances from the location of the client to locations of the plurality of sites; and accessing the logical storage by accessing a copy at the selected site.

According to aspects of the present disclosure, the selecting one site from the plurality of sites at least based on distances from the location of the client to locations of the plurality of sites comprises: selecting one site from the plurality of sites in near-to-far order; or selecting one site from the plurality of sites in near-to-far order, and in response to a selecting site being abnormal, selecting a next site from the plurality of the sites in near-to-far order.

According to aspects of the present disclosure, a site among the plurality of sites results from splitting according to locations of storage controllers in the storage cluster based on a network topological structure of the storage cluster.

According to aspects of the present disclosure, there is provided an apparatus for accessing a logical storage in a storage cluster, the storage cluster comprising a plurality of sites at different locations, each site among the plurality of sites comprising a copy corresponding to the logical storage, the apparatus comprising: an obtaining module configured to, in response to receiving an access request from a client, obtain a location of the client; a selecting module configured to select one site from the plurality of sites at least based on distances from the location of the client to locations of the plurality of sites; and an accessing module configured to access the logical storage by accessing a copy at the selected site.

According to aspects of the present disclosure, the selecting module comprises: a first selecting module configured to select one site from the plurality of sites in near-to-far order; or a second selecting module configured to select one site from the plurality of sites in near-to-far order, and in response to a selecting site being abnormal, selecting a next site from the plurality of the sites in near-to-far order.

According to aspects of the present disclosure, a site among the plurality of sites results from splitting according to locations of storage controllers in the storage cluster based on a network topological structure of the storage cluster.

The method and apparatus according to the various embodiments of the present disclosure may be implemented without changing existing configuration of the storage cluster as far as possible. Specifically, the storage cluster is split into different sites based on a location relationship between storage servers and storage controllers in the storage cluster, and a storage server and a storage controller at a site that is near to the client respond to a request from the client. Thereby, the response latency caused by factors like network transmission latency may be reduced greatly and further the data access efficiency increased.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the invention. The drawings are only illustrative of certain embodiments and do not limit the invention.

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 schematically shows an exemplary computer system/server which is applicable to implement the embodiments of the present disclosure;

FIG. 2 shows a schematic view of a storage cluster architecture according to embodiments of the present disclosure.

FIG. 3 shows a schematic view of an architecture of a storage cluster according to embodiments of the present disclosure.

FIG. 4 schematically shows a flowchart of a method for accessing a logical storage in a storage cluster according to embodiments of the present disclosure.

FIG. 5 shows a schematic view of performing a read operation to a logical storage in a storage cluster according to embodiments of the present disclosure.

FIG. 6 shows a schematic view of performing a write operation to a logical storage in a storage cluster according to embodiments of the present disclosure.

FIG. 7 shows a schematic view of an apparatus for accessing a logical storage in a storage cluster according to embodiments of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

In the drawings and the Detailed Description, like numbers generally refer to like components, parts, steps, and processes.

### DETAILED DESCRIPTION

The present disclosure may be a system, a method, and/or a computer program product. The computer program product may include a computer readable storage medium (or media) having computer readable program instructions thereon for causing a processor to carry out aspects of the present disclosure.

Certain embodiments will be described in more detail with reference to the accompanying drawings, in which the embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

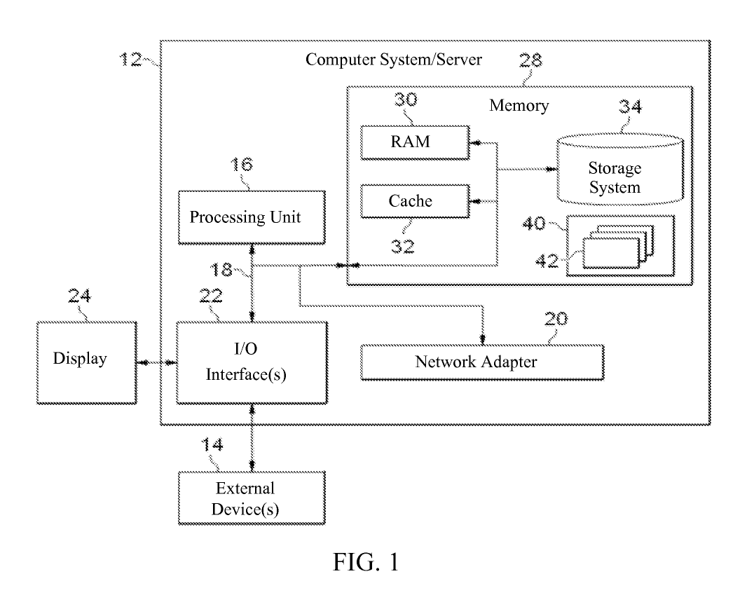

Referring now to FIG. 1, in which an exemplary computer system/server 12 which is applicable to implement the embodiments of the present disclosure is shown. Computer system/server 12 is only illustrative and is not intended to suggest any limitation as to the scope of use or functionality of embodiments of the disclosure described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

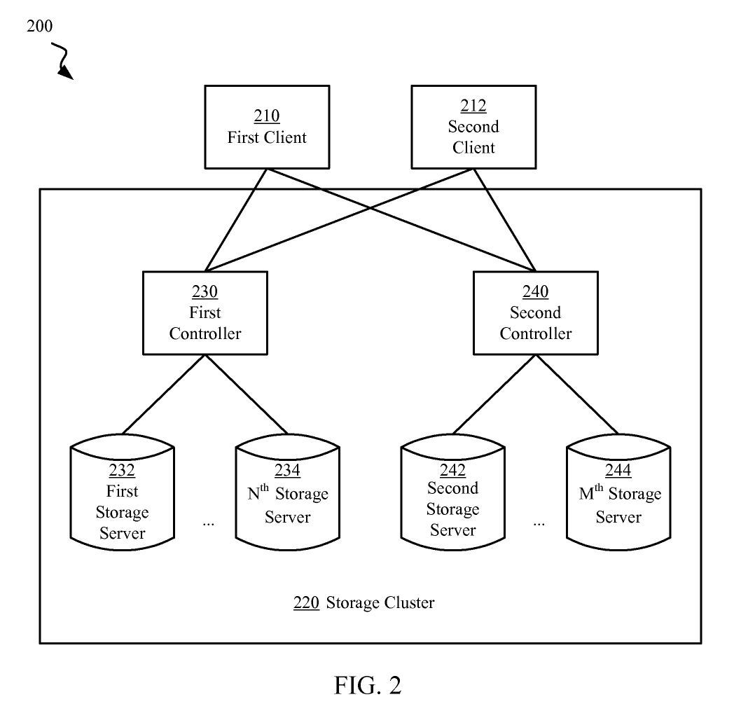

FIG. 2 shows a schematic view 200 of an architecture of a storage cluster according to one embodiment. As shown in this figure, to increase the reliability of the storage cluster, a plurality of copies of a logical storage may be provided in the storage cluster, and users at clients (e.g., a first client 210 and a second client 212) may access the logical storage via a plurality of paths provided by a storage cluster 220. For example, storage cluster 220 may be distributed across multiple cities like Beijing and Shanghai. For example, a first controller 230 may be deployed in Beijing, while a second controller 240 may be deployed at Shanghai.

In this embodiment, when a user in Beijing (e.g., first client 210) is allocated with a logical storage (e.g., “F: Drive”), and a preferred node of the logical storage is second controller 240, the user accesses data in the logical storage via a path of first client 210—second controller 240—logical storage (e.g., a first storage server 242 or an M^{th} storage server 244). Since first client 210 and second controller 240 are located in Beijing and Shanghai respectively, data has to be transmitted between Beijing and Shanghai via a network, to support the user's access to the logical storage. Due to the restriction of network bandwidths and possible latency in various network devices, the data access efficiency of storage cluster 220 shown in FIG. 2 may be rather unsatisfactory.

In addition, the same virtual storage (LUN) has to provide services for clients at different physical locations. However, in traditional implementation methods, one LUN can only provide a single controller as a preferred path, so some clients cannot access data via the nearest controller.

In view of the drawbacks in the above embodiment, the present disclosure provides a solution where the same LUN can automatically provide different preferred paths for clients at different physical locations, thereby reducing the response time of the storage cluster and further increasing the data access efficiency. Specifically, according to the various embodiments of the present disclosure, a location relationship between a client and various storage controllers in the storage cluster may be taken into consideration, and a storage controller that is closer to the client responds to an access request from the client based on the location relationship.

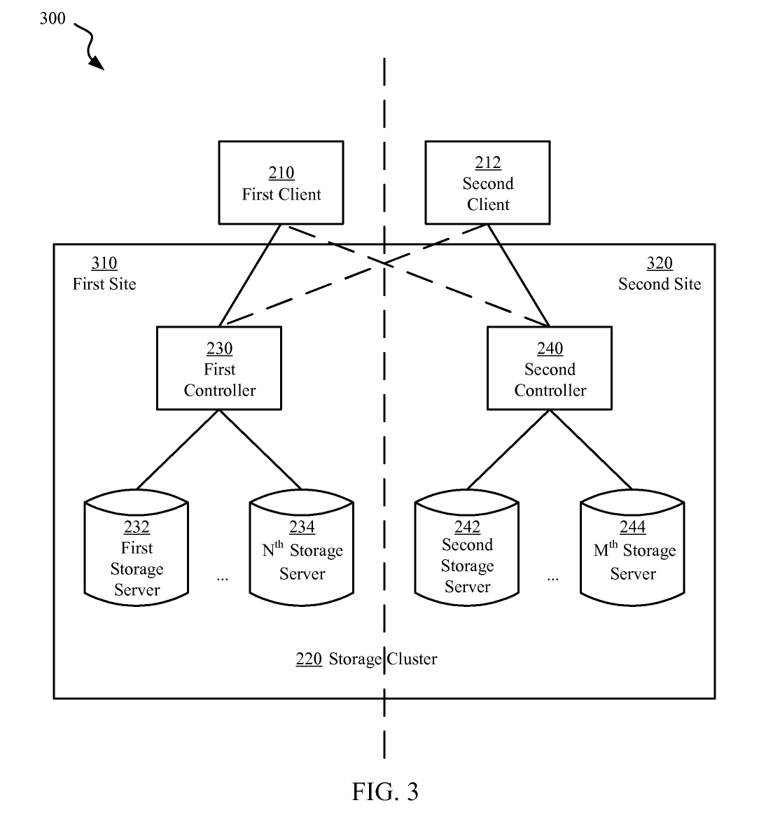

FIG. 3 shows a schematic view 300 of a storage cluster according to one embodiment of the present disclosure. As shown in this figure, a site concept is proposed in the embodiments of the present disclosure; sites are divided according to locations of storage controllers in the storage cluster based on a network topological structure of the storage cluster. As shown in FIG. 3, there exist two storage controllers, namely first controller 230 (for example, in Beijing) and second controller 240 (for example, in Shanghai), so the whole storage cluster 220 may be split into two sites based on locations of these two controllers. At this point, a first site 310 comprises first controller 230 and a first storage server 232, . . . , an N^{th} storage server 234 under the management of first controller 230, and a second site 320 comprises second controller 240 and a first storage server 242, . . . , an M^{th} storage server 244 under the management of second controller 240. Note although FIG. 3 shows only two sites, one skilled in the art may further set other number of sites according to a concrete application environment. In addition, although in FIG. 3 cities serve as a basis for site splitting, in other embodiments the splitting may be implemented based on another standard.

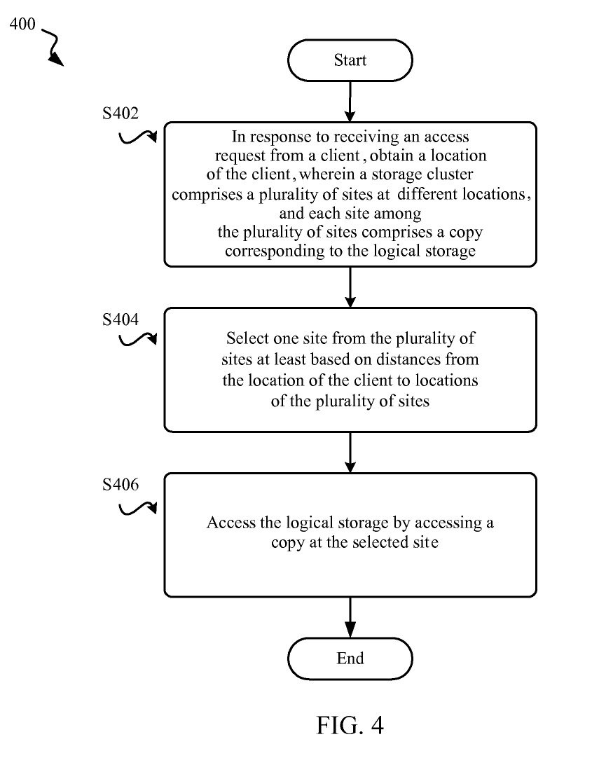

FIG. 4 schematically shows a flowchart 400 of a method for accessing a logical storage in a storage cluster according to embodiments of the present disclosure. Specifically, FIG. 4 provides a method for accessing a logical storage in a storage cluster, the storage cluster comprising a plurality of sites at different locations, each site among the plurality of sites comprising a copy corresponding to the logical storage, the method comprising: in response to receiving an access request from a client, obtaining a location of the client; selecting one site from the plurality of sites at least based on distances from the location of the client to locations of the plurality of sites; and accessing the logical storage by accessing a copy at the selected site.

Specifically, the storage cluster comprises a plurality of sites at different locations. To increase the data reliability, a copy of the logical storage may be maintained at each site among the plurality of sites, so that other site may provide storage service when a given site has failures. For example, with respect to storage cluster 220 as shown in FIG. 3, two copies may be maintained at first site 310 and second site 320 respectively.

In operation S402, in response to receiving an access request from a client, a location of the client is obtained. Those skilled in the art may use various approaches to obtaining the location of the client, for example, parsing from the access request information indicating the location of the client, looking up the location of the client based on an identifier of the client, etc.

In operation S404, one site is selected from the plurality of sites at least based on distances from the location of the client to locations of the plurality of sites. Since locations of storage controllers of the plurality of sites in the storage cluster are already known, where the location of the client is obtained in operation S402, an appropriate site may be selected from the plurality of sites according to a location relationship with the client. For example, regarding the example shown in FIG. 3, where storage cluster 220 receives a request from first client 210 and it is known first client 210 is located in Beijing, since first controller 230 of first site 310 is also located in Beijing, first site 310 may be selected.

In operation S406, the logical storage is accessed by accessing a copy in the selected site. Regarding the example shown in FIG. 3, suppose the logical storage that the user wants to access is mapped to first storage server 232 at first site 310, then first storage server 232 may be accessed via first site 310 so as to provide the user with data access service.

At this point, the user can access storage space within the storage cluster based on the logical storage, and information within the storage cluster is transparent to the user. In fact, the user accesses a physical storage device to which the logical storage is mapped, via a path of first client 210—first storage server 232 at first site 310. According to the embodiment described above, on the basis that a plurality of access paths are provided for reliable data storage service, a site in the storage cluster which is closer to the client responds to the access request from the client.

In embodiments of the present disclosure, the selecting one site from the plurality of sites at least based on distances from the location of the client to locations of the plurality of sites comprises: selecting one site from the plurality of sites in near-to-far order; or selecting one site from the plurality of sites in near-to-far order, and in response to a selecting site being abnormal, selecting a next site from the plurality of the sites in near-to-far order.

Note since a distance from the client to a site may affect the speed the client accesses a logical storage at the site, preferably a site with the shortest distance may be selected in near-to-far order.

In addition, since the storage cluster might have failures, a device at the selected site with the shortest distance is abnormal, a site with the shortest distance may be selected from remaining sites to respond to the access request from the client. Specifically, various selection policies may be provided. For example, a list of candidate sites may be provided according to distances from the client to sites. When a site with the highest priority has failures, a site with the next priority is selected in an order according to the list; or a site which is currently optimal may be provided only, and when the site has failures, other optimal site is selected from remaining sites.

Specifically, with respect to the storage cluster shown in FIG. 3, when a device at first site 310 that is the nearest to first client 210 has failures, second site 320 may respond to first client 210 (as shown by a dashed line) so as to guide the access request from first client 320 to a corresponding storage server at second site 320.

In embodiments of the present disclosure, the distance between the client and the site comprise at least one of a physical distance and a logical distance. Generally speaking, the longer the distance from the client to the site, the longer the physical length of an access path between them; where latency of various devices in the network are not taken into consideration, the time for data transmission therebetween becomes longer. Therefore, the site whose physical location is the nearest to the client responds to the access request from the client, thereby reducing the access time.

On the other hand, when consideration is given to bandwidths of network devices and latency of various network devices during transmission, there might further arise a circumstance below: although the distance from the client to the site is not long, network congestion leads to a high bit error rate and further conditions like retransmission which seriously impact the transmission efficiency, at which point a site (e.g., site with fewest “hops”) that is the logically nearest to the client may be selected to respond to the access request from the client.

In embodiments of the present disclosure, a site among the plurality of sites results from splitting according to locations of storage controllers in the storage cluster based on a network topological structure of the storage cluster. Note that each site may comprise one storage controller for managing one or more storage servers at the site. In the various embodiments of the present disclosure, since the storage controller and the storage server managed by the storage controller are usually located at adjacent physical locations, the storage controller and the storage server managed by the storage controller may be dispatched to the same site. Thereby, a storage controller that is near to the client may respond to requests from the client, and in turn a storage server that is near to the client may be accessed to provide data read/write service. Since a location of the selected site is physically near to the client, the network transmission time can be reduced and further the data access efficiency enhanced.

In embodiments of the present disclosure, the location of the client is stored in association with an identifier of the client and an address mapping relationship, the address mapping relationship describing a relationship between an access address of the logical storage and a physical address of at least one storage server at a site in the storage cluster.

In this embodiment, the location of the client may be stored, and the location is stored in association with the client's identifier and with a physical location (i.e., address mapping relationship between the logical storage and a physical address) of a logical storage in the storage cluster which is allocated to the client. In embodiments of the present disclosure, implementation may be achieved by adding a “client's location” field to existing mapping configuration, for example.

In embodiments of the present disclosure, the accessing the logical storage by accessing a copy at the selected site comprises: accessing a copy at the selected site by the storage controller at the selected site based on the address mapping relationship and an access address of the logical storage in the access request.

In this embodiment, the storage controller acts an agent between the client and the physical storage in the storage cluster to guide the client to achieve data read/write operations. Specifically, the storage controller may, based on the mapping relationship between the logical storage and a physical address, map an access address for accessing the logical storage as contained in the access request from the client to a physical address, and then data is forwarded between the client and the physical address via the storage controller.

In embodiments of the present disclosure, the accessing a copy at the selected site by the storage controller at the selected site based on the address mapping relationship and an access address of the logical storage in the access request comprises: in response to the access request being a read request, looking up data associated with the access address in the copy by the storage controller; and returning the data to the client.

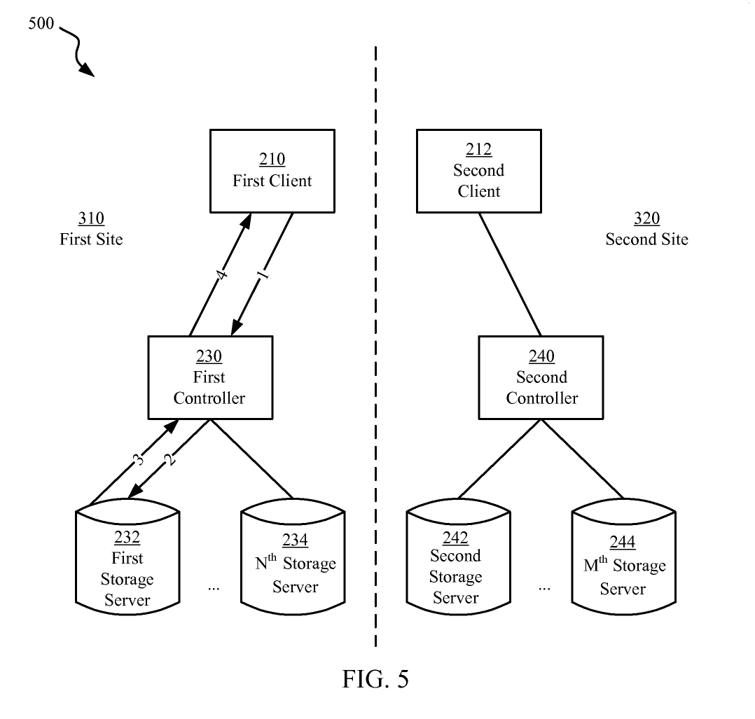

With reference to FIG. 5, detailed description is presented below to how to perform a read operation. FIG. 5 shows a schematic view 500 of performing a read operation to a logical storage in a storage cluster according to embodiments of the present disclosure. As shown in FIG. 5, first of all, an access request from first client 210 is guided to second controller 240 that is the nearest to first client 210, just as shown by arrow 1. Using the above method, it can be learned based on an access address of the logical storage and an address mapping relationship that a physical address first client 210 desires to access is a physical address in first storage server 232. At this point, first controller 230 guides the access request to first storage server 232 and looks up data associated with the access address (as shown by arrow 2). Subsequently, the data associated with the access request is returned from first storage server 232 to first controller 230 (as shown by arrow 3), and then requested data is returned to first client 210 (as shown by arrow 4). In this manner, the data read operation can be achieved through the operations shown by arrows 1-4 in FIG. 5.

In embodiments of the present disclosure, the accessing a copy at the selected site by the storage controller at the selected site based on the address mapping relationship and an access address of the logical storage in the access request comprises: in response to the access request being a write request, writing data associated with the write request to the access address in the copy by the storage controller; and synchronizing the selected site with other site among the plurality of sites.

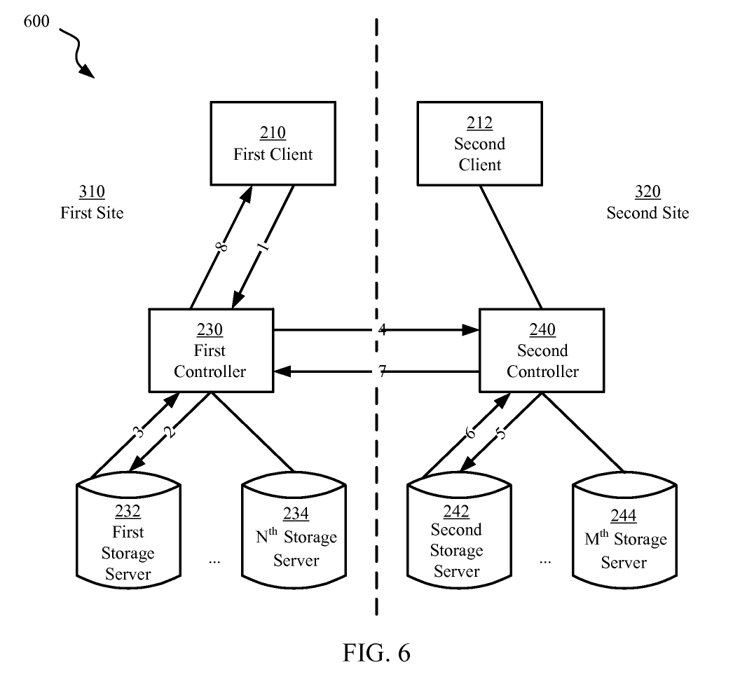

With reference to FIG. 6, detailed description is presented below to how to perform a write operation. FIG. 6 shows a schematic view 600 of performing a write operation to a logical storage in a storage cluster according to embodiments of the present disclosure. As shown in FIG. 6, first controller 230 receives a write request from first client 210 (as shown by arrow 1) and writes related data to first storage server 232 (physical storage device to which the logical storage is mapped) (as shown by arrow 2), and subsequently first storage server 232 returns to first controller 230 information indicative of write success (as shown by arrow 3).

Since the write operation will affect content of a copy in the storage cluster, when there exist a plurality of copies in the storage cluster, consistency between the plurality of copies needs to be maintained. Thereby, operations as shown by arrows 4-7 further need to be executed for synchronization between copies at various sites. Specifically, first controller 230 sends a synchronization message to second controller 240 (as shown by arrow 4), second controller 240 writes data to first storage server (as shown by arrow 5), first storage server 242 sends to second controller 240 a signal indicative of write success (as shown by arrow 6), and subsequently second controller 240 sends to first controller 230 a signal indicative of synchronization success (as shown by arrow 7). Through these operations, copies at first site 310 and second site 320 in the storage cluster can be consistent. Later, a signal indicative of write success is sent to first client 210 (as shown by arrow 8).

In embodiments of the present disclosure, there is further comprised: in response to communication between the plurality of sites failing, electing one site from the plurality of sites and setting the site to an activated state for responding to the access request; and setting other sites than the elected site to deactivated state.

Note that since it is necessary to ensure consistency between copies at the plurality of sites in the storage cluster, it should be ensured these sites can perform data communication; otherwise, after a copy at one site can be modified, since data cannot be synchronized with other sites, various data copies might be inconsistent. In this embodiment, when a communication failure between sites is detected, one site may be elected from the plurality of sites and then is set to the activated state, while other sites are set to the deactivated state. In this manner, since in the storage cluster there exists a unique site in activated state, no data synchronization operation is needed.

In certain embodiments of the present disclosure, there is further included an operation, in response to communication between the plurality of sites being recovered, of updating copies at deactivated sites by using a copy at an activated site; and setting deactivated sites to activated state. In this manner, other copies can be updated to latest state when communication is recovered.

In embodiments of the present disclosure, the logical storage can be a logical unit number (LUN). A LUN can be a token for mapping the logical storage to the physical storage, and those skilled in the art may further use other approaches to achieve mapping between the logical storage and the physical storage.

Various embodiments implementing the method of the present disclosure have been described above with reference to the accompanying drawings. Those skilled in the art may understand that the method may be implemented in software, hardware or a combination of software and hardware. Moreover, those skilled in the art may understand by implementing operations in the above method in software, hardware or a combination of software and hardware, there may be provided an apparatus based on the same disclosure concept. Even if the apparatus has the same hardware structure as a general-purpose processing device, the functionality of software contained therein makes the apparatus manifest distinguishing properties from the general-purpose processing device, thereby forming an apparatus of the various embodiments of the present disclosure. The apparatus described in the present disclosure comprises several means or modules, the means or modules configured to execute corresponding operations. Upon reading this specification, those skilled in the art may understand how to write a program for implementing actions performed by these means or modules. Since the apparatus is based on the same disclosure concept as the method, the same or corresponding implementation details are also applicable to means or modules corresponding to the method. As detailed and complete description has been presented above, the apparatus is not detailed below.

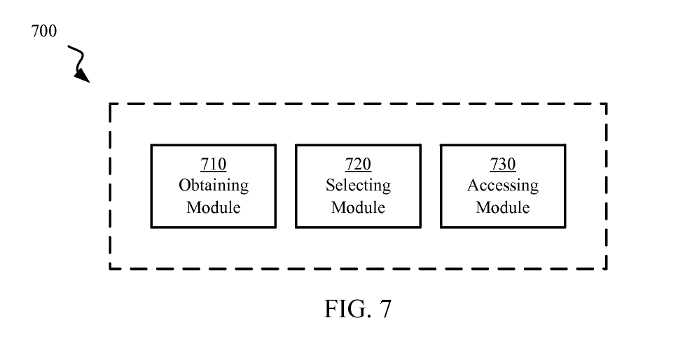

FIG. 7 shows a schematic view 700 of an apparatus for accessing a logical storage in a logical storage cluster according to embodiments of the present disclosure. As shown in FIG. 7, there is provided an apparatus for accessing a logical storage in a storage cluster, the storage cluster comprising a plurality of sites at different locations, each site among the plurality of sites comprising a copy corresponding to the logical storage, the apparatus comprising: an obtaining module 710 configured to, in response to receiving an access request from a client, obtain a location of the client; a selecting module 720 configured to select one site from the plurality of sites at least based on distances from the location of the client to locations of the plurality of sites; and an accessing module 730 configured to access the logical storage by accessing a copy at the selected site.

In embodiments of the present disclosure, selecting module 720 comprises: a first selecting module configured to select one site from the plurality of sites in near-to-far order; or a second selecting module configured to select one site from the plurality of sites in near-to-far order, and in response to a selecting site being abnormal, select a next site from the plurality of the sites in near-to-far order.

In embodiments of the present disclosure, a site among the plurality of sites results from splitting according to locations of storage controllers in the storage cluster based on a network topological structure of the storage cluster.

In embodiments of the present disclosure, the location of the client is stored in association with an identifier of the client and an address mapping relationship, the address mapping relationship describing a relationship between an access address of the logical storage and a physical address of at least one storage server at a site in the storage cluster.

In embodiments of the present disclosure, accessing module 730 can include a copy accessing module configured to access a copy at the selected site by the storage controller at the selected site based on the address mapping relationship and an access address of the logical storage in the access request.

In embodiments of the present disclosure, the distances can include at least one of a physical distance and a logical distance.

In embodiments of the present disclosure, the copy accessing module includes a write module configured to, in response to the access request being a write request, write data associated with the write request to the access address in the copy by the storage controller, and a synchronizing module configured to synchronize the selected site with other site among the plurality of sites.

Certain embodiments of the present disclosure can also include an electing module configured to, in response to communication between the plurality of sites failing, elect one site from the plurality of sites and set the site to an activated state for responding to the access request; and a first setting module configured to set other sites than the elected site to an deactivated state.

Certain embodiments of the present disclosure can also include an updating module configured to, in response to communication between the plurality of sites being recovered, update copies at deactivated sites by using a copy at an activated site; and a second setting module configured to set deactivated sites to activated state.

In particular embodiments of the present disclosure, the logical storage can be logical unit number (LUN).

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for accessing a logical storage in a storage cluster, the storage cluster comprising a plurality of sites at different locations, each site among the plurality of sites comprising a copy corresponding to the logical storage, the method comprising:
in response to receiving an access request from a client, obtaining a location of the client;
selecting one site from the plurality of sites at least based on distances from the location of the client to locations of the plurality of sites; and
accessing the logical storage by accessing a copy at the selected site.

2. The method of claim 1, wherein the selecting one site from the plurality of sites at least based on distances from the location of the client to locations of the plurality of sites comprises at least one operation of a group consisting of:
selecting one site from the plurality of sites in near-to-far order; and
selecting one site from the plurality of sites in near-to-far order, and in response to a selecting site being abnormal, selecting a next site from the plurality of the sites in near-to-far order.

3. The method of claim 1, wherein a site among the plurality of sites results from splitting according to locations of storage controllers in the storage cluster based on a network topological structure of the storage cluster.

4. The method of claim 3, wherein the location of the client is stored in association with an identifier of the client and an address mapping relationship, the address mapping relationship describing a relationship between an access address of the logical storage and a physical address of at least one storage server at a site in the storage cluster.

5. The method of claim 4, wherein the accessing the logical storage by accessing a copy at the selected site comprises:
accessing a copy at the selected site by the storage controller at the selected site based on the address mapping relationship and an access address of the logical storage in the access request.

6. The method of claim 1, wherein the distances comprise at least one of a physical distance and a logical distance.

7. The method of claim 5, wherein, in response to the access request being a write request, the accessing a copy at the selected site by the storage controller at the selected site based on the address mapping relationship and an access address of the logical storage in the access request comprises:
writing data associated with the write request to the access address in the copy by the storage controller; and
synchronizing the selected site with other site among the plurality of sites.

8. The method of claim 1, further comprising:
in response to communication between the plurality of sites failing, electing one site from the plurality of sites and setting the site to an activated state for responding to the access request; and
setting other sites than the elected site to an deactivated state.

9. The method of claim 8, further comprising:
in response to communication between the plurality of sites being recovered, updating copies at deactivated sites by using a copy at an activated site; and
setting deactivated sites to activated state.

10. The method of claim 1, wherein the logical storage is a logical unit number.

11. An apparatus for accessing a logical storage in a storage cluster, the storage cluster comprising a plurality of sites at different locations, each site among the plurality of sites comprising a copy corresponding to the logical storage, the apparatus comprising:
an obtaining module configured to, in response to receiving an access request from a client, obtain a location of the client;
a selecting module configured to select one site from the plurality of sites at least based on distances from the location of the client to locations of the plurality of sites; and
an accessing module configured to access the logical storage by accessing a copy at the selected site.

12. The apparatus of claim 11, wherein the selecting module comprises:
a first selecting module configured to select one site from the plurality of sites in near-to-far order; or
a second selecting module configured to select one site from the plurality of sites in near-to-far order, and in response to a selecting site being abnormal, selecting a next site from the plurality of the sites in near-to-far order.

13. The apparatus of claim 11, wherein a site among the plurality of sites results from splitting according to locations of storage controllers in the storage cluster based on a network topological structure of the storage cluster.

14. The apparatus of claim 13, wherein the location of the client is stored in association with an identifier of the client and an address mapping relationship, the address mapping relationship describing a relationship between an access address of the logical storage and a physical address of at least one storage server at a site in the storage cluster.

15. The apparatus of claim 14, wherein the accessing module comprises:
a copy accessing module configured to access a copy at the selected site by the storage controller at the selected site based on the address mapping relationship and an access address of the logical storage in the access request.

16. The apparatus of claim 11, wherein the distances comprise at least one of a physical distance and a logical distance.

17. The apparatus of claim 15, wherein the copy accessing module comprises:
a write module configured to, in response to the access request being a write request, write data associated with the write request to the access address in the copy by the storage controller; and
a synchronizing module configured to synchronize the selected site with other site among the plurality of sites.

18. The apparatus of claim 11, further comprising:
an electing module configured to, in response to communication between the plurality of sites failing, elect one site from the plurality of sites and set the site to an activated state for responding to the access request; and
a first setting module configured to set other sites than the elected site to an deactivated state.

19. The apparatus of claim 18, further comprising:
an updating module configured to, in response to communication between the plurality of sites being recovered, update copies at deactivated sites by using a copy at an activated site; and
a second setting module configured to set deactivated sites to activated state.

20. The apparatus of claim 11, wherein the logical storage is a logical unit number.
